(19) United States
(12) Patent Application Publication
(10) Pub. No.: US 2012/0092310 A1
(43) Pub. Date: Apr. 19, 2012

(54) SOLAR PANEL POLE MOUNT WITH PROVISIONS FOR ADVERTISING GRAPHICS

(76) Inventors: Robert Dana Lundahl, Frederick, MD (US); William Finch, New Windsor, MD (US); Robert Wesley Cutlip, Millersville, MD (US)

(21) Appl. No.: 13/271,621

(22) Filed: Oct. 12, 2011

Related U.S. Application Data
(60) Provisional application No. 61/404,991, filed on Oct. 13, 2010.

(51) Int. Cl. G09F 13/04; G09F 15/02; G06F 3/038; G09F 15/00

(52) U.S. Cl. 345/204; 40/607.01; 40/541; 40/606.14; 40/607.11; 40/607.12

(57) ABSTRACT

A robust and low-cost design to add graphics panels to a sun tracking, solar panel mounting system that can be mounted on a wide range of light poles and power poles. This design uses the promotional value of the applied graphics to further improve the economics of the solar installation resource to help speed the adoption of this distributed power generation resource.

This application claims the benefit of U.S. Provisional Application No. 61/404,991, filed Oct. 13, 2010, which is hereby incorporated by reference in its entirety.

### BACKGROUND OF THE INVENTION

1. Field of the Invention

This invention relates to solar energy electrical power collection systems and specifically to the design of a pole mounting system for solar panels that incorporates advertising, promotional or messaging graphics.

Utility poles for lighting, power, and communications are prevalent in today's landscape. They are existing industrial structures that can be utilized to support light weight appendages and most are also connected to the local electrical power grid. These are attractive features for the location of solar panels and solar power collection systems. Using existing light poles for a mounting structure greatly reduces the cost to install the solar panels and no additional real estate is required. Utilizing existing utility poles also provides an easy access to the electrical grid so that power produced by the solar panels does not need to be stored but can be “sold” back to the grid for others to use. Light poles are also frequently located in areas of commerce where there is pedestrian traffic that provides an attractive opportunity for advertisement and other promotional purposes.

In general, the installation of distributed solar power collection systems is a challenging economic case due to the cost of the installation and the relative financial benefit from the power generated. Thus far the growth of the market for solar energy products and installations is heavily dependent on State and Federal subsidies to make them viable economic endeavors. Creating new revenue streams for each solar installation improves the economics and encourages wider and faster adoption of solar technologies.

Needs exist for improved pole-mounted solar power collection systems.

2. Brief Description of Prior Art

Prior art shows several different static mounting configurations for solar panels where the emphasis has been on low cost and flexibility in the physical interface with the pole itself.

U.S. Pat. No. 4,265,433 titled “Pole Mounted Solar Panel Assembly” describes a technique where the solar panel mounting brackets are constructed from sheet metal and formed into two 3-dimensional shapes that are attached to the poles separately with a plurality of hose clamp-type fasteners. This is certainly a simple and low cost approach and could be applied to a variety of pole structures such as light poles. However, there are no provisions for mounting graphical panels and the geometry of the supporting structure does not provide a planar surface or series of edges where attachment provisions could be added to attach such a panel.

U.S. Pat. No. 4,368,962 titled “Solar Tracking Apparatus and System” describes an equatorial tracking system designed for solar devices. This tracking system is also aligned with the Earth's polar axis and incorporates an additional automatic adjustment for the yearly change in the Earth's axis relative to the sun. This device is not a low cost approach for mounting of a solar panel or accomplishing a sun tracking function. It incorporates many moving parts: rotating shafts, gears, and the gimbaled mounting structure for the solar device itself. There are no provisions for the attachment of any graphical panels and the geometry of the supporting structure does not provide a planar surface or series of edges where attachment provisions could be added to attach such a panel.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

A new design for a low cost solar panel pole mounting system accepts pre-printed snap-on panels that can be custom printed for a wide range of promotional purposes. The installation efficiencies of a pole mounted system combined with value of promotional graphics enhance the overall economics as a system and can provide the pivotal economic justification to make many such projects viable.

The principal application for this design is to enhance the economics of distributed power generation solar cells mounted on utility poles. However, it should be obvious to one skilled in the art that any pole-type structure may be utilized to include both fixed and sun tracking mounting systems.

Sun Tracking provides additional collection efficiencies and yields more energy per year than fixed systems. The sun tracking mechanism provides additional challenges for the design to place all actuators and moving components in places where they will not interfere with the graphics banners themselves.

A new mounting structure has a construction that forms two opposing faces of planar edges where graphical panels are attached. One embodiment includes a sun tracking mechanism that is also accommodated by this design and does not interfere with the application of graphical panels. The graphical panel themselves may be fabricated in a variety of ways and in some embodiments are attached with stainless steel marine-type fasteners. This is a time-tested outdoor tested approach for the installation of banners and coverings.

A unique design for a solar panel pole mount incorporates a means to attach graphical panels one either side for additional revenue generation. The embodiment shown in the figures incorporates a sun tracking function in the mount with the graphical panels installed without interference with the move mechanism.

A previous application Ser. No. 13/064,198 made by the same inventors provides a detailed description of the mounting structure and sun tracking mechanism and is hereby incorporated by reference. Several descriptions from that application are repeated below for clarification and convenience.

This embodiment of the pole-mounted solar panel mount is an equatorial or “polar mount” style tracker. It is inexpensive to build and optimized for installation on conventional light poles. The frame of the tracker is formed with a channel that is bent into a “C” shaped structure. The solar panel is supported with several cross members that are attached to a rotating shaft that turns the panel to track the sun. The channel that forms the “C” shaped structure has two flanges that are parallel to each other and wrap the length of the frame. Multiple snap features are incorporated on these flanges. Fabric-style or solid panels with graphics are fitted to either side of the mounting structure using the snap features on the sides of the “C” shaped channel structure. Marine snaps are shown in the illustrated embodiment, since they are a standard approach that does not require tools and they are used in this type of outdoor environment. Marine-style snaps also support the frequent attachment and replacement of the graphics panels that affix to the frame.

Many different designs for the pole mounted structure can be envisioned, and are anticipated by this invention. The embodiment described in this invention is a simple and low cost approach to providing both a low-cost structure for a tracking array and the physical features to support the attachment of replaceable graphics panels. With a simple and low-cost design, many such devices can be installed on large sets of light poles and collectively provide a significant advertising and power generation resource. Simplicity, low cost, and ease of installation are key attributes of this design and critical for its intended utility.

A single “C” shaped mounting structure is designed to be clamped to the mounting pole. The structure itself is simple and designed to utilize modern low cost manufacturing techniques such as laser-cut sheet metal, tube bending, and folded construction.

The mount structure is attached to the pole using a common “U” bolt style connection from the mount to encircle and capture the pole. Specialized cradles are used between the mount structure and the pole itself. In this way the same mount can have a solid and secure interface with a variety of poles by simply changing the cradle configuration. Both round and square poles and straight or tapered profiles in a variety of sizes can be accommodated. The installation procedure is simple and always the same regardless of the pole sizes. Holes for common “lag bolts” are also provided to allow the mount structure to be attached directly to an appropriate wooden wall, post, column, fencepost, or even a tree.

The “C” shaped mounting structure incorporates a simple pivot point out on the end of each one of the legs. An axle is defined by these two pivot points. The legs of the “C” shaped structure have different lengths to create an angle between the pivot point axle and vertical. The length of the two legs is chosen so that the axle is canted at the same angle as the Earth's axis on the solar equinox and the entire mount is connected to the pole structure with the lower arm pointing due south. This configuration places the axle in a position parallel to the Earth's axis and is a fundamental feature of a polar or equatorial mount system.

The actual solar panel is supported by crossbars attached to the axle of the mount structure. One of the support bars is fitted with a large hemispherical section gear rack that interfaces with a geared motor installed in the lower arm of the “C” shaped support structure. The pinion gear of the geared motor drives the rack to rotate the axle and the solar panel to track the sun.

The graphics panels are attached with snaps to the sides of the support frame and are below the pivoting axle of the solar panel. In this way the panel can rotate on its equatorial axis without interference.

### OBJECT OF THE INVENTION

An object of this invention is to provide a pole mounting system for solar panels that will support the solar panel and also provide an area for the attachment of graphics panels that can be used for a variety of promotional purposes.

A further object of this invention is to provide a design where a solar panel can be powered to track the sun with a 1-axis, equatorial style tracking mount that is low cost and easily manufactured and will not cause physical interference with the graphics panels that are attached to the support frame.

A further object of this invention is to provide a new source of revenue from the promotional graphics to enhance the overall economies of the solar power system and help speed its introduction into the market and rapidly expand the distributed generation capability of these devices.

These and further and other objects and features of the invention are apparent in the disclosure, which includes the above and ongoing written specification, with the drawings.

### BRIEF DESCRIPTION OF DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. (1) Pole mounted Equatorial Tracker—This illustration shows the end configuration of a utility light pole that has been outfitted with a pole-mounted solar panel with a mounting structure that incorporates graphics panels for promotional or other purposes.

FIG. (2) Tracker construction and components—This illustration shows how the graphics panels could be easily attached to the solar panel mounting frame using simple marine-type snaps.

### DETAILED DESCRIPTION OF THE DRAWINGS

A solar panel pole mount with provisions for advertising graphics will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

The description is not to be taken in a limiting sense, but is made merely for the purpose of illustrating the general principles of the invention, since the scope of the invention is best defined by the appended claims.

The following sections describe only one embodiment of this invention where the graphics panels are snap-on banners. It should be obvious that there are several other methods for creating a graphics sign and many other methods for attaching it to the mounting structure that supports the solar panel.

FIG. (1) shows a light pole (1) with a tracking panel mount (2) installed. This mount may be an active tracker or a simple stationary mount. The solar panel (3) is supported by the mount in an appropriate direction. The graphics panels (4) are attached to the mount frame and will not interfere with the motion of the solar panel (3) if it is a tracking mount. It is anticipated that a graphics panel (4) would be installed on either side of the mount to maximize their visibility for the promotional purpose intended. Graphics could be the same on both sides or they could be individual and different. It is also anticipated that the graphics panels could be something other than simple printed banners. The panels could be rigid panels, they could be clear and backlit with some active illumination, or they could even be active computer generated display units.

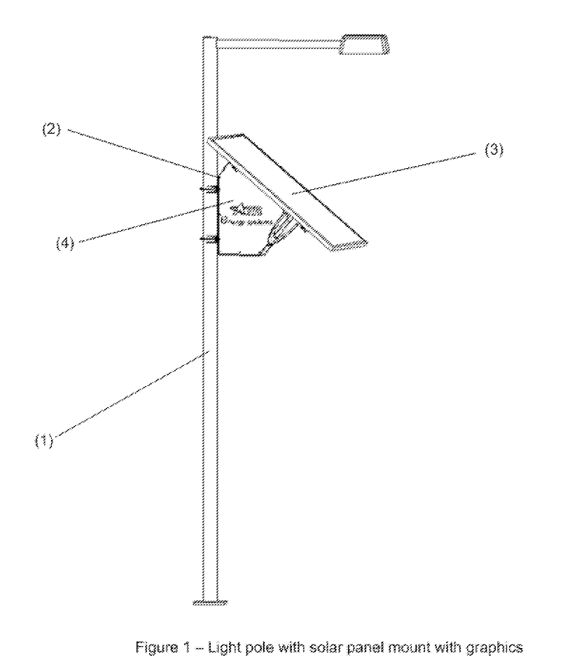

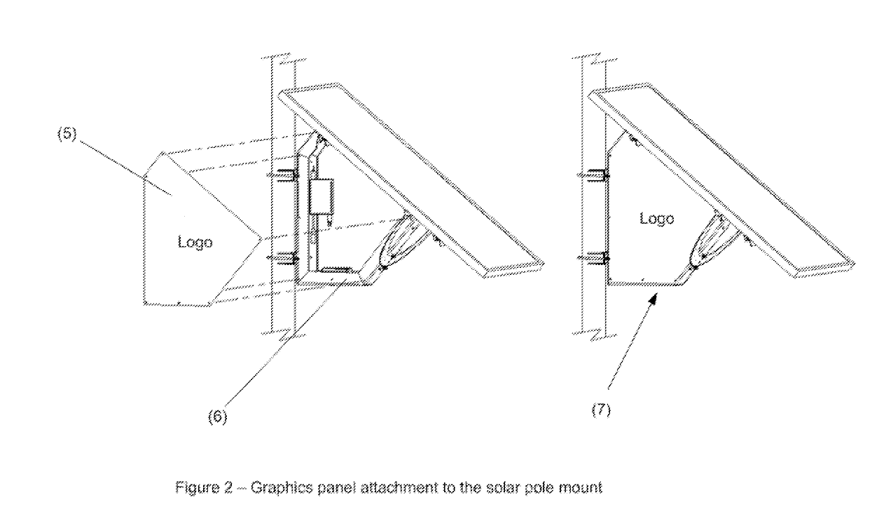

FIG. (2) shows how the graphics panels (5) could be applied to the solar panel pole mount structure (6) in this embodiment. Panels would be applied on either side of the mount structure. The actual panel construction would likely be a flexible banner-type material with marine-type snaps. The pole mounted solar panel with graphic panels assembly (7) provides a single assembly for power generation and advertising. As discussed in FIG. 1, several different banner configurations are anticipated by this invention. The graphic panels (5) could be flexible, rigid, backlit, or active displays. All of these methods are within the scope of this invention where the revenue or promotional value of the graphics are utilized to add economic benefit to the solar installation and speed the adoption of this distributed power generation resource.

The invention is not limited to the particular embodiments illustrated in the drawings and described above in detail. Those skilled in the art will recognize that other arrangements could be devised, as discussed above. The invention encompasses every possible combination of the various features of each embodiment disclosed. While the invention has been described with reference to specific illustrative embodiments, modifications and variations of the invention may be constructed without departing from the spirit and scope of the invention as set forth in the following claims.

What is claimed:

1. A graphic sign solar panel mounting apparatus, comprising:
a mounting structure configured to support at least one solar panel to generate electricity and to attach to pole structures; and
one or more graphic signs attached to sides of the mounting bracket;
wherein said mounting bracket comprises fasteners attaching the graphic signs to the mounting bracket;
wherein said graphic signs provide advertising or promotional value that supplement the value of the power generated by said at least one solar panel.

2. The graphic sign solar panel mounting apparatus of claim 1, wherein said mounting structure is attached to a utility power pole.

3. The graphic sign solar panel mounting apparatus of claim 1, wherein said mounting structure is attached to a generic pole structure.

4. The graphic sign solar panel mounting apparatus of claim 1, wherein the graphic signs are backlit for illumination to enhance viewing.

5. The graphic sign solar panel mounting apparatus of claim 1, wherein the graphic signs are electronic and display information that is pre-programmed.

6. The graphic sign solar panel mounting apparatus of claim 1, wherein the graphic signs are electronic and display information that is delivered by a data interface.

7. The graphic sign solar panel mounting apparatus of claim 1, wherein the mounting structure further comprises a sun tracking mechanism, wherein the graphics panels are attached below a pivoting axle of the solar panel such that the panel can rotate on its pivoting axle without interference.

8. The graphic sign solar panel mounting apparatus of claim 7, wherein the sun tracking mechanism is a 1-axis, equatorial style tracking mount.

9. The graphic sign solar panel mounting apparatus of claim 1, wherein the mounting structure further comprises a frame,
wherein the frame comprises a “C” shaped channel comprising parallel flanges running the length of the frame,
wherein the flanges comprise the fasteners.

10. The graphic sign solar panel mounting apparatus of claim 9, wherein the mounting structure further comprises a “U” bolt-style connection comprising a cradle configured to encircle and capture a pole and secure it to the mounting frame.

11. The graphic sign solar panel mounting apparatus of claim 9, wherein the mounting structure further comprises holes for “lag bolts” for attachment directly to a wooden structure.

12. The graphic sign solar panel mounting apparatus of claim 9, wherein the frame comprises pivot points on either end of the “C” shaped channel that define an axle.

13. The graphic sign solar panel mounting apparatus of claim 12, wherein the axle is canted at the same angle as the Earth's axis on the solar equinox and the lower end of the “C’ shaped channel points due South.

14. The graphic sign solar panel mounting apparatus of claim 12, wherein the mounting structure further comprises crossbars attached to the axle and configured to support the at least one solar panel.

15. The graphic sign solar panel mounting apparatus of claim 14, wherein one of the crossbars is fitted with a large hemispherical section gear rack that interfaces with a geared motor installed in a lower arm of the “C” shaped channel, wherein a pinion gear of the geared motor is configured to drive the rack to rotate the axle and any solar panel attached to the axle to track the sun.

16. The graphic sign solar panel mounting apparatus of claim 12, wherein the one or more graphic signs are attached to the frame below the axle.

17. A solar panel mounting apparatus, comprising:
a mounting structure configured to support at least one solar panel to generate electricity and to attach to pole structures;
wherein the mounting structure comprises a frame;
wherein the frame comprises a “C” shaped element;
wherein the mounting structure further comprises a “U” bolt-style connection comprising a cradle configured to encircle and capture a pole and secure it to the mounting frame;
wherein the frame comprises pivot points on either end of the “C” shaped element that define an axle;
wherein the axle is canted at the same angle as the Earth's axis on the solar equinox and the lower end of the “C’ shaped element points due South.

18. The solar panel mounting apparatus of claim 17, wherein the mounting structure further comprises crossbars attached to the axle and configured to support the at least one solar panel, wherein one of the crossbars is fitted with a large hemispherical section gear rack that interfaces with a geared motor installed in a lower arm of the “C” shaped element, wherein a pinion gear of the geared motor is configured to drive the rack to rotate the axle and any solar panel attached to the axle to track the sun.

19. The solar panel mounting apparatus of claim 17, wherein the mounting structure further comprises holes for “lag bolts” for attachment directly to a wooden structure;
